(19) United States
(12) Patent Application Publication
(10) Pub. No.: US 2023/0097510 A1
(43) Pub. Date: Mar. 30, 2023

(54) ALUMINUM BASE COMPOSITE MATERIAL, METHOD OF MANUFACTURING THE SAME, AND ELECTRICAL CONNECTION MEMBER

(71) Applicants: Hayato IKEYA, Shizuoka (JP); Kazuhiro OHGUSHI, Shizuoka (JP); Shinobu KAYAMA, Shizuoka (JP); Satoru YOSHINAGA, Shizuoka (JP)

(72) Inventors: Hayato IKEYA, Shizuoka (JP); Kazuhiro OHGUSHI, Shizuoka (JP); Shinobu KAYAMA, Shizuoka (JP); Satoru YOSHINAGA, Shizuoka (JP)

(21) Appl. No.: 17/954,776

(22) Filed: Sep. 28, 2022

(30) Foreign Application Priority Data
Sep. 29, 2021 (JP) 2021-159066

(51) Int. Cl. H01R 13/03; H01M 50/522; H01M 50/562; F16B 33/00

(52) U.S. Cl. CPC H01R 13/03; H01M 50/522; H01M 50/562; F16B 33/00; H01M 2220/20; H01R 2201/26

(57) ABSTRACT

An aluminum base composite material contains an aluminum polycrystal body being a polycrystal body of a plurality of aluminum base material phases partitioned by a grain boundary, a carbon nanotube part being formed of a carbon nanotube or an aggregate thereof and being dispersed in at least one aluminum base material phase, and an alumina part being formed of alumina and being dispersed in at least one aluminum base material phase. The carbon nanotube preferably has a sphere-equivalent diameter from 10 nm to 300 nm, and the number of the carbon nanotube part that is present in a cross-sectional area of 200 μm² of the aluminum base composite material is preferably one or more.

### CROSS-REFERENCE TO RELATED APPLICATIONS

The present application is based on, and claims priority from the prior Japanese Patent Application No. 2021-159066, filed on Sep. 29, 2021, the entire contents of which are incorporated herein by reference.

### TECHNICAL FIELD

The present disclosure relates to an aluminum base composite material, a method of manufacturing the same, and an electrical connection member.

### BACKGROUND

As a wiring member for an automobile, an electrical connection member such as a bus bar, a terminal, a bolt, and a nut is used. Such an electrical connection member is also used at a heat generating part such as an engine unit of an automobile and a member in a vicinity of a battery. The heat generating part is approximately at a temperature of 150° C., for example.

Furthermore, when an electronic connection member used at a heat generating part of an automobile has creep characteristics, stress relaxation resistance characteristics, and the like that are degraded at a high temperature of, for example, 150° C., a problem is likely to occur. For example, in a case in which the electronic connection member is a coupling tool such as a bolt and a nut, when the coupling tool has creep characteristics degraded at a high temperature, there may be a risk that the coupling tool is loosened. Thus, the electronic connection member used at a heat generating part of an automobile preferably has excellent creep characteristics, stress relaxation resistance characteristics, and the like at a high temperature so that the electronic connection member can reliably be used under a stress loading state in a high temperature environment.

Various materials applicable to the electronic connection member have been proposed. JP2015-34330A discloses an aluminum alloy plate for an electronic connection component, the aluminum alloy plate being formed of an aluminum alloy containing Si and Mg by specific amounts and Al as the remaining part.

JP2015-199982A discloses an aluminum base composite material containing a metal base material and a carbon nanotube conductive path part. The metal base material is formed of a polycrystal body of a plurality of bar-like metal crystal particles, and the carbon nanotube conductive path part is formed of a carbon nanotube and is present in a specific shape along a longitudinal direction of the metal base material.

However, the aluminum alloy plate disclosed in JP2015-34330A may have a risk that conductivity is reduced due to Mg₂Si or the like deposited in Al. Further, Mg₂Si is deposited at a temperature from approximately 140° C. to approximately 180° C., which easily affects dynamic characteristics significantly. Thus, the aluminum alloy plate disclosed in JP2015-34330A may have a risk that creep characteristics, stress relaxation resistance characteristics, and the like at a high temperature of approximately 150° C. are degraded.

Further, JP2015-199982A does not disclose an aluminum base composite material having excellent creep characteristics, stress relaxation resistance characteristics, and the like at a high temperature of 150° C.

In view of the above-mentioned problem in the related art, the present disclosure has been achieved while focusing on creep characteristics being plastic deformation behavior at a high temperature of, for example, 150° C. An object of the present disclosure is to provide an aluminum base composite material having excellent creep characteristics at a high temperature, a method of manufacturing the same, and an electronic connection member.

### SUMMARY

An aluminum base composite material according to an aspect of the present disclosure contains an aluminum polycrystal body being a polycrystal body of a plurality of aluminum base material phases partitioned by a grain boundary, a carbon nanotube part being formed of a carbon nanotube or an aggregate thereof and being dispersed in at least one of the plurality of aluminum base material phases, and an alumina part being formed of alumina and being dispersed in at least one of the plurality of aluminum base material phases.

A method of manufacturing an aluminum base composite material according to another aspect of the present disclosure includes a CNT-alcohol dispersion preparation step of preparing a CNT-alcohol dispersion in which a carbon nanotube is dispersed in alcohol, a raw material mixture slurry preparation step of preparing a raw material mixture slurry by adding aluminum powder in the CNT-alcohol dispersion, the raw material mixture slurry containing, in alcohol, the aluminum powder, the carbon nanotube, and alumina, a raw material mixture drying step of drying the raw material mixture slurry and producing a raw material mixture, a green compact forming step of pressurizing the raw material mixture, obtaining a preliminary compact, and forming a powder green compact, and a metal extrusion process step of subjecting the powder green compact to an extrusion process.

An electrical connection member according to another aspect of the present disclosure is formed by using the aluminum base composite material.

According to the present disclosure, the aluminum base composite material having excellent creep characteristics at a high temperature, the method of manufacturing the same, and the electrical connection member can be provided.

### BRIEF DESCRIPTION OF THE DRAWINGS

FIG. 1 is an example of a scanning electron microscopic (SEM) photograph of a cross section of an aluminum base composite material according to an embodiment (Example 1).

FIG. 2 is an example of an enlarged photograph of FIG. 1.

FIG. 3A is an example of an enlarged photograph of FIG. 1, which is obtained by further enlarging FIG. 2.

FIG. 3B is a carbon mapping image of a region shown in FIG. 3A, which is obtained by an energy dispersive X-ray spectroscopy (EDS).

FIG. 4 is an example of a transmission electron microscopic (TEM) photograph in a magnifying manner, focusing on carbons in FIG. 3A.

FIG. 5A is an example of an EDS analysis result of a black point BK₁ in FIG. 1.

FIG. 5B is an example of an EDS analysis result of a white point WH₁ in FIG. 1.

FIG. 6 is an example of a graph showing a relationship between a particle area of a large number of alumina parts (alumina part cross-sectional area) and a frequency, the large number of alumina parts being present in the cross section of the aluminum base composite material shown in FIG. 1.

FIG. 7 is an example of a creep test result.

FIG. 8 is an example of a graph showing a relationship of yield stress, maximum stress (tensile strength), and elongation that are obtained by performing heat treatment and softening under predetermined conditions for an aluminum base composite material after work-hardening, which is subjected to plastic deformation by a wire drawing process after an extrusion process, and an aluminum base composite material after work-hardening.

FIG. 9 is an example showing a relationship between an addition amount of a carbon nanotube, and surface areas of aluminum powder having different shapes and a surface area of the carbon nanotube in a raw material.

FIG. 10 is an example of a scanning electron microscopic (SEM) photograph of a surface of aluminum powder in a raw material mixture slurry in Example 1.

FIG. 11 is an example of a scanning electron microscopic (SEM) photograph of a cross section of an aluminum base composite material in Comparative Example 4.

FIG. 12 is an example of a method of manufacturing an aluminum base composite material according to an embodiment.

### DETAILED DESCRIPTION

Various embodiments will be described hereinafter with reference to the accompanying drawings.

An aluminum base composite material, a method of manufacturing the same, and an electrical connection member according to the present embodiment are described below. Note that dimensional ratios in the drawings are overdrawn for convenience of description, and may be different from actual ratios in some cases.

### [Aluminum Base Composite Material]

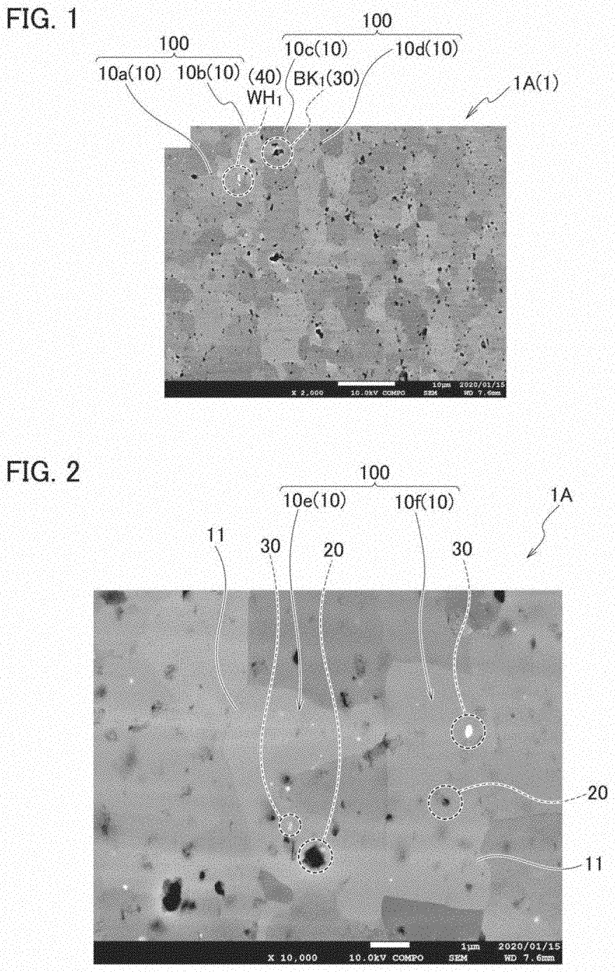

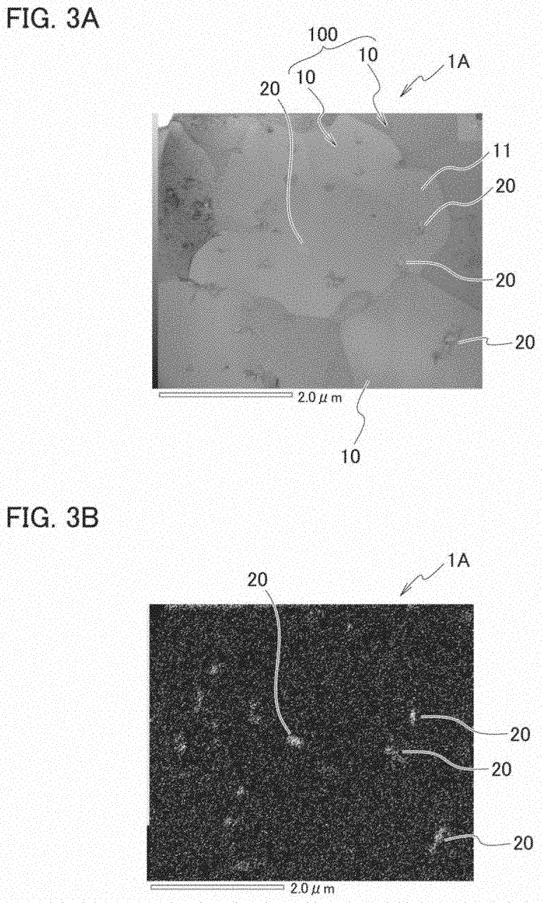

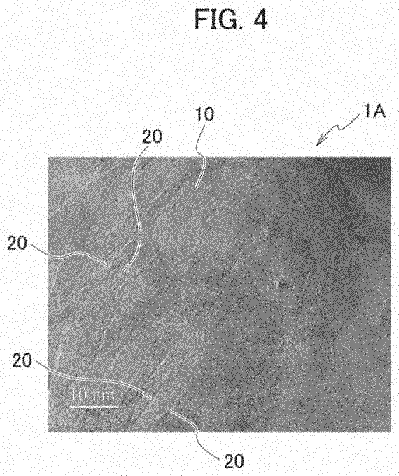

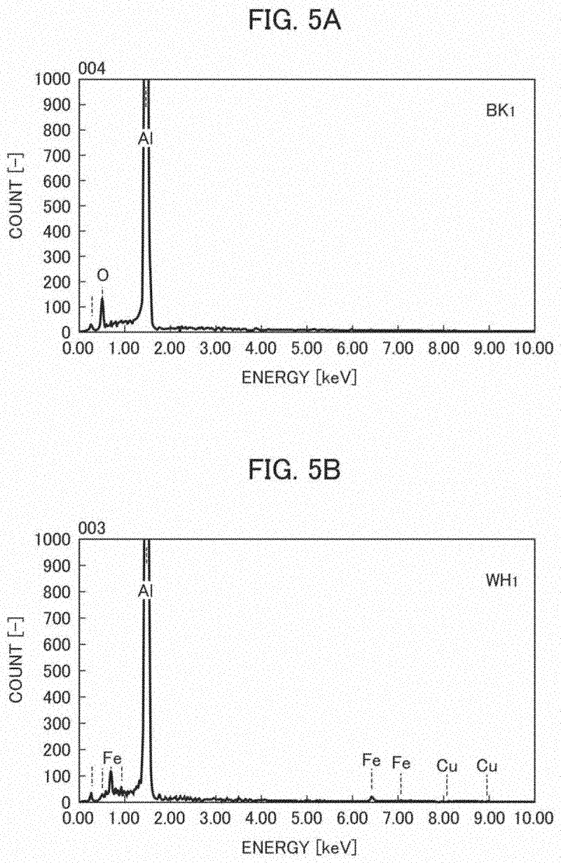

FIG. 1 is an example of a scanning electron microscopic (SEM) photograph of a cross section of an aluminum base composite material according to an embodiment (Example 1). FIG. 2 is an example of an enlarged photograph of FIG. 1. FIG. 3A is an example of an enlarged photograph of FIG. 1, which is obtained by further enlarging FIG. 2. FIG. 3B is a carbon mapping image of a region shown in FIG. 3A, which is obtained by an energy dispersive X-ray spectroscopy (EDS). FIG. 4 is an example of a transmission electron microscopic (TEM) photograph in a magnifying manner, focusing on carbons in FIG. 3A. FIG. 5A is an example of an EDS analysis result of a black point BK₁ in FIG. 1. FIG. 5B is an example of an EDS analysis result of a white point WH₁ in FIG. 1.

As shown in FIG. 1 and FIG. 2, the aluminum base composite material 1A (1) according to the embodiment contains an aluminum polycrystal body 100, a carbon nanotube part 20, an alumina part 30, and an impurity-derived dispersion part 40. The aluminum base composite material 1A is an example of a bar-shaped material after an extrusion process. Note that, as a modification example of the aluminum base composite material 1A, there may be adopted a configuration in which the impurity-derived dispersion part 40 is omitted. In this modification example, the aluminum polycrystal body 100, the carbon nanotube part 20, and the alumina part 30 are contained.

### (Aluminum Base Material Phase)

The aluminum polycrystal body 100 is a polycrystal body of a plurality of aluminum base material phases 10 partitioned by a grain boundary. FIG. 1 shows aluminum base material phases 10a, 10b, 10c, and 10d as examples of a large number of the aluminum base material phases 10 forming the aluminum polycrystal body 100.

Further, FIG. 2 shows aluminum base material phases 10e and 10f as examples of a large number of the aluminum base material phases 10 forming the aluminum polycrystal body 100. All the aluminum base material phases 10 mainly contain base material parts 11 being aluminum crystal particles that are substantially formed of only aluminum besides inevitable impurities.

A part other than the base material part 11 in the aluminum base material phase 10 is also referred to as a dispersion part. In the aluminum base composite material 1A according to the embodiment, the carbon nanotube part 20, the alumina part 30, and the impurity-derived dispersion part 40 correspond to dispersion parts. The impurity-derived dispersion part 40 is formed of a compound containing one or more elements selected from a group consisting of Fe, Cu, Si, Mn, Ti, and Zn.

The aluminum base material phase 10 is an aluminum crystal in which the dispersion part is dispersed in the base material part 11 that is only formed of an aluminum crystal particle containing aluminum as a main component. The base material part 11 is an aluminum crystal particle that does not contain the dispersion part, and the aluminum base material phase 10 is an aluminum crystal particle that contains the base material part 11 and the dispersion part.

The base material part 11 and the aluminum base material phase 10 share the same particle boundary formed with another aluminum base material phase 10. Thus, the base material part 11 and the aluminum base material phase 10 have the same outer crystal particle shape. Thus, the outer shape of the aluminum base material phase 10 is the same as the outer shape of the base material part 11. The outer shape of the aluminum base material phase 10, that is, the outer shape of the base material part 11 is not particularly limited. In general, the outer shape thereof is a shape having specific orientation or a shape without orientation in accordance with extrusion process conditions.

The size of the aluminum base material phase 10 is not particularly limited. Here, for example, the size of the aluminum base material phase 10 is expressed by using a diameter (μm) obtained by approximating an aluminum crystal particle to a perfect circle, based on a cross-sectional area of the aluminum crystal particle observed in a photograph of the cross section of the aluminum base composite material 1A. The diameter (μm) of the aluminum base material phase 10 is, for example, 1 μm to 20 μm, preferably 2 μm to 10 μm, more preferably 2 μm to 5 μm. When the diameter of the aluminum base material phase 10 falls within the above-mentioned range, the aluminum base composite material achieving both strength and ductility in a compatible manner at a high level can be obtained, which is preferred. In general, according to Hall-Petch relation, when the crystal particle size is reduced, strength of the aluminum base composite material is improved. Thus, when strength of the aluminum base composite material 1A is to be further increased, the diameter may be beyond the above-mentioned range. Further, the aluminum base material phase 10 is preferably an isometric crystal.

### <Base Material Part>

The base material part 11 contains, for example, 99.0 to 99.9 parts by mass, preferably 99.4 to 99.8 parts by mass of aluminum in 100 parts by mass of the base material part 11. The content amount of aluminum preferably falls within the above-mentioned range in terms of commercial availability, material costs, and excellent conductive characteristics, mechanical characteristics, and the like of the aluminum base composite material 1A. Note that, when the base material part 11 contains substances other than aluminum, the substances are inevitable impurities. Examples of the inevitable impurities include Si, Fe, Cu, Mn, and Ti.

### <Carbon Nanotube Part>

The carbon nanotube part 20 is formed of a carbon nanotube or an aggregate thereof, and is a part dispersed in at least one aluminum base material phase 10.

The carbon nanotube part 20 is dispersed in at least one aluminum base material phase 10 of the large number of aluminum base material phases 10 forming the aluminum polycrystal body 100.

It is considered that, in the aluminum base material phase 10, the carbon nanotube part 20 inhibits dislocation movement such as restoration, recrystallization, and elastoplastic deformation due to transfer of dislocation or disappearance of the aluminum base material phase 10. Thus, when the carbon nanotube part 20 is dispersed in the large number of aluminum base material phases 10 forming the aluminum polycrystal body 100, the aluminum base composite material 1A has excellent creep characteristics at a high temperature, which is preferred.

With reference to FIG. 2, FIG. 3A, and FIG. 3B, it can be understood that the carbon nanotube part 20 is dispersed in each of the base material parts 11 forming the aluminum base material phases 10.

Further, with reference to FIG. 2, it can be understood that the carbon nanotube part 20 and the alumina part 30 described later are dispersed in each of the base material parts 11 forming the aluminum base material phases 10e and 10f.

The carbon nanotube part 20 is formed of a carbon nanotube or an aggregate thereof, and is a part dispersed in the aluminum base material phase 10. Here, a carbon nanotube aggregate indicates an aggregate formed by aggregating a plurality of carbon nanotubes. The carbon nanotube aggregate may be formed as an aggregate of a plurality of carbon nanotubes arrayed in substantially the same direction, an aggregate of a plurality of carbon nanotubes arrayed in a random manner, or the like.

The length of the carbon nanotube forming the carbon nanotube part 20 is 1 μm to 3,000 μm, preferably 1 μm to 1,000 μm. When the length of the carbon nanotube falls within the above-mentioned range, fiber reinforcement is realized, strength of the aluminum base composite material 1A is easily increased, and excellent creep characteristics at a high temperature is achieved, which is preferred.

In general, the carbon nanotube or the carbon nanotube aggregate that forms the carbon nanotube part 20 has a sphere-equivalent diameter from 10 nm to 300 nm, preferably from 10 to 200 nm. Here, when the carbon nanotube or the carbon nanotube aggregate is regarded as a sphere having the same surface area as that of the carbon nanotube or the carbon nanotube aggregate, the sphere-equivalent diameter indicates a diameter (nm) of the sphere.

For example, the above-mentioned sphere-equivalent diameter is a diameter (nm) obtained by approximating the carbon nanotube or the carbon nanotube aggregate to a perfect circle, based on a cross-sectional area of the carbon nanotube or the carbon nanotube aggregate observed in a photograph of the cross section of the aluminum base composite material. When the above-mentioned sphere-equivalent diameter falls within the above-mentioned range, dispersion reinforcement due to Orowan mechanism is realized, strength of the aluminum base composite material 1A is easily increased, and excellent creep characteristics at a high temperature is achieved, which is preferred.

Note that the carbon nanotube part 20 shown in FIG. 4 is a carbon nanotube aggregate, specifically, a band-like aggregate of a plurality of carbon nanotubes arrayed in substantially the same direction. Note that the carbon nanotube part 20 formed of the band-like aggregate of the plurality of carbon nanotubes has a lattice interval of approximately 0.34 nm, which is observed in FIG. 4. With this, it can be understood that the image is a carbon-derived lattice image.

FIG. 3B is an EDS carbon mapping image of a region shown in FIG. 3A. Based on comparison between FIG. 3A and FIG. 3B, the shape of the carbon mapping image of FIG. 3B substantially matches with the shape of the carbon nanotube part 20 in FIG. 3A. With this, it can be understood that the carbon nanotube part 20 in FIG. 3A is formed of carbon.

One or more, preferably three or more carbon nanotube parts 20 are present in a cross-sectional area of 200 μm² of the aluminum base composite material 1A. Further, 64 or less, preferably 30 or less carbon nanotube parts 20 are present in the cross-sectional area of 200 μm² of the aluminum base composite material 1A. When the number of carbon nanotube parts 20 that are present in the cross-sectional area of the aluminum base composite material 1A falls within the above-mentioned range, the aluminum base composite material 1A has excellent creep characteristics at a high temperature, which is preferred.

The aluminum base composite material 1A contains, for example, 0.1 to 1.0 parts by mass, preferably 0.4 to 0.5 parts by mass, more preferably 0.43 to 0.44 parts by mass of the carbon nanotube part 20 in 100 parts by mass of the aluminum base composite material 1A. When the content amount of the carbon nanotube part 20 falls within the above-mentioned range, the aluminum base composite material 1A has both excellent manufacturability and excellent creep characteristics at a high temperature at the same time, which is preferred.

The carbon nanotube part 20 is present by a specific amount per square micrometer of the cross-sectional area of the cross section of the aluminum base composite material 1A, and the number of the carbon nanotube parts 20 observed in the cross section of the aluminum base composite material 1A is referred to as a CNT-part cross-section number. Specifically, the CNT-part cross-section number in the cross section of the aluminum base composite material 1 is, for example, 1 to 20/μm², preferably 3 to 15/μm², more preferably 5 to 10/μm². When the CNT-part cross-section number falls within the above-mentioned range, the aluminum base composite material 1A has both excellent manufacturability and excellent creep characteristics at a high temperature at the same time, which is preferred. For example, the CNT-part cross-section number is calculated as the number of the respective carbon nanotube parts 20, which is specified by subjecting the SEM photograph of the cross section of the aluminum base composite material 1A to image processing.

The carbon nanotube part 20 is present by a specific amount in a cross-sectional area of 3,000 μm² of the cross section of the aluminum base composite material 1A, and the cross-sectional area of the carbon nanotube part 20 observed in the cross section of the aluminum base composite material 1A is referred to as a CNT-part cross-sectional area. Specifically, the CNT-part cross-sectional area is 0.075 μm² to 67.90 μm², preferably 0.075 μm² to 30.16 μm² in the cross-sectional area of 3,000 μm² of the aluminum base composite material 1A. When the CNT-part cross-sectional area falls within the above-mentioned range, the aluminum base composite material 1A has both excellent manufacturability and excellent creep characteristics at a high temperature at the same time, which is preferred. For example, the CNT-part cross-sectional area is calculated as the cross-sectional area of the respective carbon nanotube part 20, which is specified by subjecting the SEM photograph of the cross section of the aluminum base composite material 1A to image processing.

### <Alumina Part>

The alumina part 30 is formed of alumina Al₂O₃, and is a part dispersed in at least one aluminum base material phase 10.

The alumina part 30 is dispersed in at least one aluminum base material phase 10 of the large number of aluminum base material phases 10 forming the aluminum polycrystal body 100.

It is considered that, in the aluminum base material phase 10, the alumina part 30 inhibits dislocation movement such as restoration, recrystallization, and elastoplastic deformation due to transfer of dislocation or disappearance of the aluminum base material phase 10. Thus, when the alumina part 30 is dispersed in the large number of aluminum base material phases 10 forming the aluminum polycrystal body 100, the aluminum base composite material 1A has excellent creep characteristics at a high temperature, which is preferred.

FIG. 1 shows the aluminum base material phases 10a, 10b, 10c, and 10d formed of a large number of aluminum crystal particles and the black point BK₁ dispersed in the aluminum base material phase 10c.

FIG. 5A is an example of an EDS analysis result of the black point BK₁ in FIG. 1. With reference to FIG. 5A, the black point BK₁ contains aluminum Al and oxygen O, and hence it can be understood that the black point BK₁ corresponds to the alumina part 30 formed of Al₂O₃.

With reference to FIG. 1 and FIG. 5A, it can be understood that the alumina part 30 is dispersed in the base material part 11 forming the aluminum base material phase 10c.

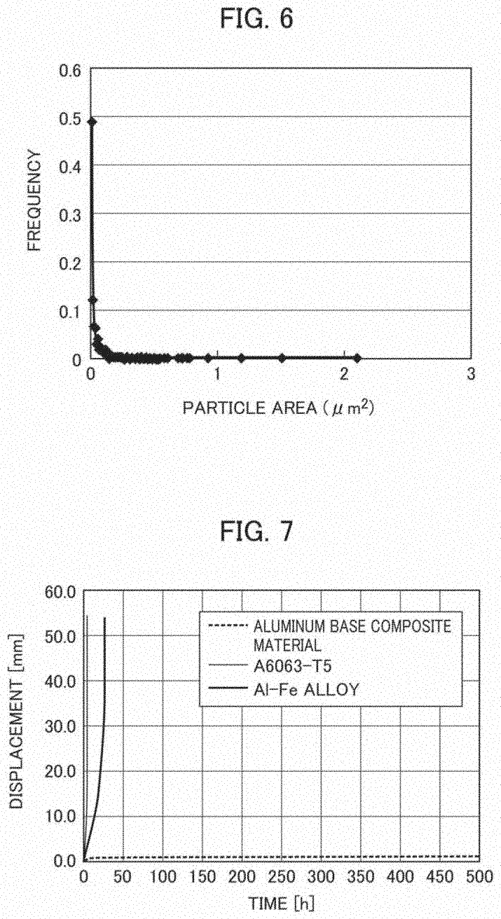

FIG. 6 is an example of a graph showing distribution of cross-sectional areas of a large number of alumina parts present in the cross section of the aluminum base composite material shown in FIG. 1. Specifically, FIG. 6 is a graph showing a relationship between cross-sectional areas and a frequency of the alumina parts present in the cross-sectional area of 3,000 μm² of the cross section of the aluminum base composite material shown in FIG. 1. With reference to FIG. 6, it can be understood that the particle area of the alumina parts 30 falls within a range from 0.075 μm² to 67.90 μm² in the cross-sectional area of 3,000 μm² of the cross section of the aluminum base composite material 1A.

Further, with reference to FIG. 2, it can be understood that the alumina part 30 is dispersed in each of the base material parts 11 forming the aluminum base material phases 10e and 10f.

Moreover, with reference to FIG. 2, it can be understood that the carbon nanotube part 20 and the alumina part 30 are dispersed in each of the base material parts 11 forming the aluminum base material phases 10e and 10f.

The aluminum base composite material 1A contains, for example, 0.05 to 0.70 parts by mass, preferably 0.10 to 0.50 parts by mass, more preferably 0.20 to 0.40 parts by mass of the alumina part 30 in 100 parts by mass of the aluminum base composite material 1A. When the content amount of the alumina part 30 falls within the above-mentioned range, the aluminum base composite material 1A has excellent creep characteristics at a high temperature, which is preferred.

The alumina part 30 is present by a specific amount per square micrometer of the cross sectional area of the cross section of the aluminum base composite material 1A, and the number of the alumina parts 30 observed in the cross section of the aluminum base composite material 1A is referred to as an alumina-part cross-section number. Specifically, the alumina-part cross-section number in the cross section of the aluminum base composite material 1A is, for example, 20 to 80/μm², preferably 30 to 70/μm², more preferably 40 to 59/μm². When the alumina-part cross-section number falls within the above-mentioned range, the aluminum base composite material 1A has excellent creep characteristics at a high temperature, which is preferred. For example, the alumina-part cross-section number is calculated as the number of the respective alumina parts 30, which is specified by subjecting the SEM photograph of the cross section of the aluminum base composite material 1A to image processing.

The alumina part 30 is present by a specific amount in the cross-sectional area of 3,000 μm² of the cross section of the aluminum base composite material 1A, and the cross-sectional area of the alumina part 30 observed in the cross section of the aluminum base composite material 1A is referred to as an alumina-part cross-sectional area. Specifically, the alumina-part cross-sectional area is 0.02 μm² to 2.5 μm², preferably 0.02 μm² to 1.0 μm² in the cross-sectional area of 3,000 μm² of the aluminum base composite material 1A. When the alumina-part cross-sectional area falls within the above-mentioned range, the aluminum base composite material 1A has excellent creep characteristics at a high temperature, which is preferred. For example, the SEM photograph of the cross section of the aluminum base composite material 1A is subjected to image processing for binarization, and each of the alumina parts 30 is indicated with the black point after the binarization. The alumina-part cross-sectional area is calculated as an area of those alumina parts 30, each of which is approximated to a perfect circle.

### <Impurity-Derived Dispersion Part>

The impurity-derived dispersion part 40 is formed of a compound containing one or more elements selected from a group consisting of Fe, Cu, Si, Mn, Ti, and Zn, and is a part dispersed in at least one aluminum base material phase 10.

FIG. 1 shows the white point WH₁ dispersed in the aluminum base material phase 10a (10).

FIG. 5B is an EDS analysis result of the white point WH₁ in FIG. 1. With reference to FIG. 5B, the white point WH₁ contains Al, Fe, and Cu. With this, it can be understood that the white point WH₁ corresponds to the impurity-derived dispersion part 40 formed of an inter-metal compound of Al, Fe, and Cu.

With reference to FIG. 1 and FIG. 5B, it can be understood that the impurity-derived dispersion part 40 is dispersed in the base material part 11 forming the aluminum base material phase 10a.

The aluminum base composite material 1A contains, for example, 0.1 to 0.4 parts by mass, preferably 0.1 to 0.3 parts by mass of the impurity-derived dispersion part 40 in 100 parts by mass of the aluminum base composite material 1A. Here, the amount of the impurity-derived dispersion part 40 indicates a total amount of inevitable impurities formed of a compound containing one or more elements selected from a group consisting of Fe, Cu, Si, Mn, Ti, and Zn. When the content amount of the impurity-derived dispersion part 40 falls within the above-mentioned range, conductivity of the aluminum base composite material 1A can be prevented from being reduced, which is preferred.

In the aluminum base composite material 1A, the dispersion parts correspond to the carbon nanotube part 20, the alumina part 30, and the impurity-derived dispersion part 40.

### (Characteristics)

The aluminum base composite material 1A has conductivity of 58% IACA or higher, preferably 60% IACA or higher. Further, the aluminum base composite material 1A has 0.2% proof stress of 40 MPa or more, preferably 81 MPa or more, which is measured at a room temperature of 25° C. Conductivity and 0.2% proof stress may be measured by publicly known methods.

The aluminum base material phase 10 of the aluminum base composite material 1A is formed of high-purity aluminum without a yield point. Further, a mass ratio of the aluminum base material phase 10 is the highest in the aluminum base composite material 1A. Thus, in the aluminum base composite material 1A, stress is measured as 0.2% proof stress being stress for generating permanent set of 0.2% after removing stress.

With regard to the aluminum base composite material 1A, tensile strength of an unprocessed composite material after extrusion, which corresponds to an unprocessed aluminum base composite material 1A after an extrusion process, is preferably 120 MPa or more, more preferably 135 MPa or more, further more preferably 145 MPa or more. Here, the term “unprocessed” indicates that physical treatment or chemical treatment, that is, a process other than “aging treatment” is not performed.

Further, breaking elongation of the aluminum base composite material 1A as the unprocessed composite material after extrusion is preferably 10% or more, more preferably 20% or more. When breaking elongation of the unprocessed composite material after extrusion falls within the above-mentioned numerical value range, the aluminum base composite material 1A after an extrusion process can easily be subjected to a process such as bending and twisting for obtaining a product shape, which is preferred.

### (Effects)

The aluminum base composite material 1A has excellent creep characteristics at a high temperature, specifically, creep characteristics at 150° C.

Creep characteristics of the aluminum base composite material 1A can be measured by a creep test. For example, as the creep test, there is adopted a method of measuring a relationship between time and displacement by applying a load corresponding to 80% of a value of 0.2% proof stress to a polygonal pillar test piece having a width of 20 mm, a thickness of 3 mm, and a length of 200 mm under a condition of a temperature of 150° C. in the atmosphere.

In the above-mentioned creep test, creep rupture does not occur to the aluminum base composite material 1A after passing of 500 hours. Further, in the above-mentioned creep test, displacement of the aluminum base composite material 1A after passing of 500 hours is small, for example, approximately 1.1 mm. Thus, the aluminum base composite material 1A has excellent creep characteristics at a high temperature of 150° C. or the like.

Note that, when an aluminum alloy A6063-T5 is used in place of the aluminum base composite material 1A, creep rupture occurs after passing of approximately 4.3 hours, for example, and displacement at the time of rupture also exceeds 50 mm. Thus, A6063-T5 does not have satisfactory creep characteristics. Further, when an Al—Fe alloy is used in place of the aluminum base composite material 1A, creep rupture occurs after passing of approximately 26.9 hours, for example, and displacement at the time of rupture also exceeds 50 mm. Thus, an Al—Fe alloy does not have satisfactory creep characteristics.

The aluminum base composite material 1A has excellent creep characteristics at a high temperature of 150° C. or the like. The reason for this is assumed as follow. It is considered that the aluminum base composite material 1A has small creep deformation and less creep rupture because the microscopic structure of the aluminum base composite material 1A inhibits transfer of dislocation, growth, dislocation movement such as restoration.

Specifically, in the aluminum base composite material 1A, the carbon nanotube part 20 and the alumina part 30 that are dispersed in the aluminum base material phase 10 are nanosized. Thus, based on the fact that the nanosized carbon nanotube part 20 and the nanosized alumina part 30 inhibit dislocation movement described above and delay deformation leading to creep rupture in the aluminum base composite material 1A, it is assumed that creep characteristics at a high temperature of 150° C. or the like is satisfactory.

Further, the aluminum base composite material 1A as the unprocessed composite material after extrusion has high tensile strength and large breaking elongation.

For example, the aluminum base composite material 1A according to the embodiment is manufactured by the method of manufacturing an aluminum base composite material according to the embodiment given below.

### [Method of Manufacturing Aluminum Base Composite Material]

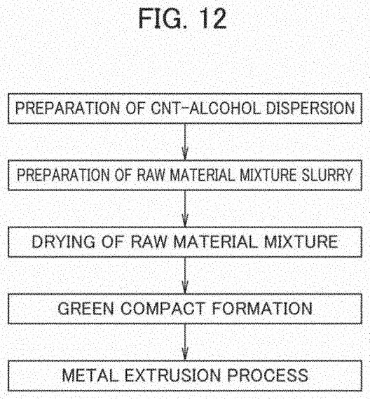

The method of manufacturing an aluminum base composite material according to the embodiment includes a CNT-alcohol dispersion preparation step, a raw material mixture slurry preparation step, a raw material mixture drying step, a green compact forming step, and a metal extrusion process step. FIG. 12 shows an example of the method of manufacturing an aluminum base composite material according to the embodiment. The manufacturing method shown in FIG. 12 is shown in an expression without using the term “step”.

### (CNT-Alcohol Dispersion Preparation Step)

The CNT-alcohol dispersion preparation step is a step of preparing a CNT-alcohol dispersion in which a carbon nanotube is dispersed in an alcohol.

For example, 2-propanol, ethanol, methanol, 2-methyl-1-propanol, 1-butanol, 1-octanol, benzyl alcohol, or the like is used as the alcohol. Among those, 2-propanol is relatively inexpensive in industrial fields, and has satisfactory dispersiveness as a dispersion solvent, which is preferred. When aluminum powder is added to the CNT-alcohol dispersion, the alcohol constituting the CNT-alcohol dispersion suppresses further formation of an alumina Al₂O layer on a surface of an aluminum particle constituting the aluminum powder. Note that addition of the aluminum powder to the CNT-alcohol dispersion is performed in the raw material mixture slurry preparation step described later.

The carbon nanotube used in the aluminum base composite material 1A is also used as the carbon nanotube. Note that the carbon nanotube may be subjected to washing with acid in advance so as to remove a metal catalyst such as platinum or amorphous carbon, or may be subjected to high-heat treatment in advance and be graphitized. By subjecting the carbon nanotube to such a pre-process, the carbon nanotube can be highly purified or highly crystalized.

The length of the carbon nanotube is from 1 μm to 3,000 μm, preferably 1 μm to 1,000 μm. When the length of the carbon nanotube falls within the above-mentioned range, fiber reinforcement is realized, strength of the aluminum base composite material 1A is easily increased, and excellent creep characteristics at a high temperature is achieved, which is preferred.

The carbon nanotube or the carbon nanotube aggregate that forms the carbon nanotube part 20 has a sphere-equivalent diameter from 10 nm to 300 nm, preferably 10 nm to 200 nm. When the above-mentioned sphere-equivalent diameter falls within the above-mentioned range, dispersion reinforcement due to Orowan mechanism is realized, strength of the aluminum base composite material 1A, which is thus obtained, is easily increased, and excellent creep characteristics at a high temperature is achieved, which is preferred.

For example, a method of emitting ultrasonic waves to a CNT-alcohol mixture being an alcohol mixture containing the carbon nanotube, a method of stirring the CNT-alcohol mixture with a stirring/mixing device such as a milling device, or the like is used as the method of preparing the CNT-alcohol dispersion. When the milling device is used, a carbon nanotube aggregate is unwound, and is dispersed finely, which is preferred. Stirring/mixing with the milling device is performed for 1 minute to 120 minutes, for example.

When the CNT-alcohol dispersion has viscosity from 1 mPa·s to 3,000 mPa·s at a temperature of 25° C., the carbon nanotube is satisfactorily dispersed without precipitation, which is preferred. Note that, when the CNT-alcohol dispersion in which the carbon nanotube precipitates is used, the carbon nanotube contained in the aluminum base composite material 1A remains large in a micrometer to millimeter order, and is more likely to aggregate. In this case, degradation of strength, creep rupture at an early stage due to partial concentration of stress at the time of creep deformation, or the like easily occurs to the aluminum base composite material 1A, which is not preferred.

With this step, the CNT-alcohol dispersion in which the carbon nanotube is dispersed in the alcohol is obtained.

### (Raw Material Mixture Slurry Preparation Step)

The raw material mixture slurry preparation step is a step of adding aluminum powder to the CNT-alcohol dispersion and preparing a raw material mixture slurry containing the aluminum powder, the carbon nanotube, and alumina in the alcohol.

For example, aluminum powder containing, as inevitable impurities, one or more elements selected from a group consisting of Fe, Cu, Si, Mn, Ti, and Zn is used as the aluminum powder added to the CNT-alcohol dispersion. Further, for example, aluminum powder having a spherical shape or a flat shape is used as the aluminum powder added to the CNT-alcohol dispersion. Here, the spherical shape indicates that its aspect ratio falls within a range from 1 to 2. Further, the aspect ratio indicates a value defined as (maximum major axis/width orthogonal to maximum major axis) in a microscopic image of a particle of the aluminum powder. Moreover, the flat shape indicates that the aspect ratio exceeds 2.

Note that, as an index indicating a degree of flatness of a particle, a flatness rate may be used. Here, the flatness rate indicates a rate (Df/Ds) of a powder diameter Df (μm) of a flattened particle after flattening with respect to a powder diameter Ds (μm) of a spherical particle before flattening. When the aluminum powder is flattened, the flatness rate is set to, for example, 1.2 to 4, preferably 1.5 to 3.0.

When the aluminum powder is exposed to the atmosphere or an oxidizing atmosphere, in general, a natural oxidized film of alumina Al₂O₃ is formed on the surface of the aluminum particle constituting the aluminum powder.

In a case in which the aluminum powder having a flat shape is used, when the aspect ratio is 1 or greater, the surface area of the aluminum powder is increased, the area to which the carbon nanotube adheres is increased, and thus the mixing amount of the carbon nanotube can be increased without aggregation, which is preferred. When the content amount of the carbon nanotube in a raw material mixture is larger as described above, creep characteristics of the aluminum base composite material 1A is more likely to be improved, which is preferred.

Here, the raw material mixture indicates a mixture containing the aluminum powder, the carbon nanotube, and alumina Al₂O₃. Only the natural oxidized film of alumina of alumina Al₂O₃ formed on the surface of the aluminum particle constituting the aluminum powder may be used, alumina mixed in addition to the aluminum powder, or a combination thereof may be used as alumina Al₂O₃ constituting the raw material mixture.

Note that, when the surface area of the carbon nanotube in the raw material mixture is excessively larger than the surface area of the aluminum powder, the excessive carbon nanotube aggregates, and is dispersed in an aluminum bulk. With this, the carbon nanotube does not contribute to dispersion reinforcement, and may be a starting point of rupture, which is not preferred. Further, when the total surface area of the carbon nanotube is excessively larger than the total surface area of the aluminum powder, the carbon nanotube does not efficiently contribute to strength and is wasted. Thus, in view of an economic reason and creep characteristics at a high temperature, which is provided to the aluminum base composite material 1A to be obtained, it is preferred that the surface area of the carbon nanotube be prevented from being excessively larger than the surface area of the aluminum powder in the raw material mixture. For example, it is preferred that the surface area of the carbon nanotube in the raw material mixture be equal to or smaller than the surface area of the aluminum powder. When the aluminum powder having a flat shape is used, the surface area of the aluminum powder can be increased as compared to a case in which the aluminum powder having a spherical shape. With this, the mixing amount of the carbon nanotube in the raw material mixture can be increased, which is preferred.

FIG. 9 is an example showing a relationship between an addition amount of the carbon nanotube, and surface areas of aluminum powder having different shapes and a surface area of the carbon nanotube in a raw material. The graph of “Spherical Al” in FIG. 9 shows a relationship between the mixing amount (addition amount) and a surface area of aluminum powder in the raw material mixture, the aluminum powder having a particle diameter of 10 μm and a flatness rate of 1.0. The graph of “Disk-shaped A” in FIG. 9 shows a relationship between the mixing amount (addition amount) and a surface area of aluminum powder in the raw material mixture, the aluminum powder obtained by flattening the spherical Al at a flatness rate of 3. The graph “CNT” in FIG. 9 shows a relationship of the mixing amount (addition amount) and a surface area of a carbon nanotube in the raw material mixture, the carbon nanotube having a diameter from 10 nm to 20 nm.

With reference to FIG. 9, it can be understood that, at any mixing amount, the graph “Disk-shaped Al” has a surface area larger than that in the graph “Spherical Al”. Further, with reference to FIG. 9, it can be understood that the surface area of the carbon nanotube is smaller than those of “Disk-shaped Al” and “Spherical Al” when “CNT addition amount” is small, and that the surface area of “Disk-shaped Al” and the surface area of “Spherical Al” are larger in the stated order when “CNT addition amount” is increased.

As described above, when the surface area of the carbon nanotube in the raw material mixture is excessively larger than the surface area of the aluminum powder, the carbon nanotube is wasted due to aggregation of the carbon nanotube, which is not preferred. With reference to FIG. 9, it can be understood that, as compared to “Spherical Al”, “Disk-shaped Al” enables further increase of the surface area of the carbon nanotube without wasting the carbon nanotube by increasing the mixing amount of the carbon nanotube in the raw material mixture.

In this step, when the aluminum powder is added to the CNT-alcohol dispersion, the raw material mixture slurry containing the aluminum powder, the carbon nanotube, and alumina in the alcohol is prepared.

For example, a method of adding the aluminum powder and alumina to the CNT-alcohol mixture and performing stirring with a stirring/mixing device such as a milling device may be used as the method of preparing the raw material mixture slurry. Further, for example, a method of adding the aluminum powder and alumina to the CNT-alcohol mixture and emitting ultrasonic waves may be used as the method of preparing the raw material mixture slurry.

Of those methods, the method using the milling device enables detangling of the carbon nanotube and flattening of the aluminum powder, which is preferred. For example, Spike Mill (registered trademark) is used as the milling device. Spike Mill is a bead mill of a continuous annular type. Specifically, Spike Mill has a double-cylindrical structure including a cylindrical vessel and a cylindrical rotor having an outer surface with a spike pattern formed thereon.

In Spike Mill, in a case in which beads and a process target object, and a solvent as required are fed into an annular gap between a vessel and a rotor, when the beads are in motion along with rotation of the rotor, a collision energy of the beads is applied to the process target object, and a pulverizing effect, a shearing effect, and a grinding effect are exerted on the process target object. For example, in general, the aluminum powder fed into Spike Mill is flattened due to shearing stress or the like. Examples of the beads used in Spike Mill include zirconia beads each having a diameter from 0.5 mm to 2.5 mm. Stirring/mixing with Spike Mill is performed for, for example, 1 minute to 120 minutes, preferably 10 minutes to 60 minutes, more preferably 30 minutes to 60 minutes.

In general, when the milling device is used, the carbon nanotube in the alcohol dispersion adheres to the surface of the aluminum powder due to a Van der Waals force. In this step, in general, adjustment of the shapes of the carbon nanotube and the aluminum powder, the mixing amount, and the like enables 95 mass % or more of the carbon nanotube, which is present in the raw material mixture slurry, to adhere to the surface of the aluminum powder.

When the milling device is used in this step, the milling device flattens the aluminum powder. Thus, when the milling device is used, the aluminum powder added to the CNT-alcohol dispersion may have a non-flattened shape or a flattened shape. Further, the aluminum powder may be added to the CNT-alcohol dispersion after subjecting only the aluminum powder to flattening through use of the milling device or the like in advance.

Note that, when the milling device or the like is used to flatten the aluminum powder in which the natural oxidized film of alumina of alumina Al₂O₃ is formed on the surface of the aluminum particle, in general, the natural oxidized film of alumina breaks along with deformation of the aluminum particle.

With this step, the raw material mixture slurry containing the aluminum powder, the carbon nanotube, and alumina in the alcohol is obtained.

The raw material mixture slurry is mixed so that the content amount of the carbon nanotube part 20 is appropriate in the aluminum base composite material 1A to be obtained in the metal extrusion process step. Specifically, the above-mentioned raw material mixture slurry and the above-mentioned CNT-alcohol mixture are prepared so that, for example, 0.1 to 0.9 parts by mass of the carbon nanotube part 20 is contained in 100 parts by mass of the aluminum base composite material 1A to be obtained.

### (Raw Material Mixture Drying Step)

The raw material mixture drying step is a step of preparing a raw material mixture by drying the raw material mixture slurry.

A method using an evaporator, a natural drying method, a heating method, or the lime is used as the drying method. Among those, the method using an evaporator facilitates collection and re-use of the alcohol contained in the raw material mixture slurry, which is preferred. For example, re-use of the alcohol can be performed by regenerating the collected alcohol through distillation.

With this step, the raw material mixture containing the aluminum powder, the carbon nanotube, and alumina is obtained.

The raw material mixture contains, for example, 98.6 to 99.5 parts by mass, preferably 98.9 to 99.2 parts by mass of the aluminum powder in 100 parts by mass of the raw material mixture. When the content amount of the aluminum powder falls within the above-mentioned range, the aluminum base composite material 1A has excellent creep characteristics at a high temperature, which is preferred.

The raw material mixture contains, for example, 0.1 to 0.9 parts by mass, preferably 0.4 to 0.5 parts by mass, more preferably 0.43 to 0.44 parts by mass of the carbon nanotube in 100 parts by mass of the raw material mixture. When the content amount of the carbon nanotube falls within the above-mentioned range, the aluminum base composite material 1A has excellent creep characteristics at a high temperature, which is preferred.

The raw material mixture contains, for example, 0.05 to 0.70 parts by mass, preferably 0.10 to 0.50 parts by mass, more preferably 0.20 to 0.40 parts by mass of alumina in 100 parts by mass of the raw material mixture. When the content amount of alumina in the raw material mixture falls within the above-mentioned range, the aluminum base composite material 1A has excellent creep characteristics at a high temperature, which is preferred.

When most of or all the carbon nanotubes adhere to the surface of the aluminum powder in the raw material mixture, generation of the carbon nanotube aggregate, insufficiency of the content amount of the carbon nanotube, or the like is less likely to occur. Thus, when most of or all the carbon nanotubes adhere to the surface of the aluminum powder, the aluminum base composite material 1A to be obtained has excellent creep characteristics at a high temperature, which is preferred. In general, when the surface area of the carbon nanotube and the surface area of the aluminum powder establish an appropriate relationship, most of or all the carbon nanotubes adhere to the surface of the aluminum powder due to a Van der Waals force. A case in which the surface area of the carbon nanotube and the surface area of the aluminum powder establish an appropriate relationship corresponds to a case in which the following relationship is satisfied, for example. Specifically, the surface area of the carbon nanotube is, for example, 0.5 to 1.5 times, preferably 0.8 to 1.2 times, more preferably 0.9 to 1.1 times as large as the surface area of the aluminum powder in the raw material mixture.

Note that, when the surface area of the carbon nanotube and the surface area of the aluminum powder establish an inappropriate relationship, excessive generation of the carbon nanotube aggregate, insufficiency of the content amount of the carbon nanotube, or the like is likely to occur. Thus, when the surface area of the carbon nanotube and the surface area of the aluminum powder establish an inappropriate relationship, the aluminum base composite material 1A to be obtained has unstable creep characteristics at a high temperature.

### (Green Compact Forming Step)

The green compact forming step is a step of pressurizing the raw material mixture, obtaining a preliminary compact, and forming a powder green compact.

In the green compact forming step, the above-mentioned raw material mixture is pressurized and compacted, and thus the powder green compact is formed. A publicly known method may be used as the method of pressurizing the raw material mixture. For example, there may be adopted a method of pressuring the raw material mixture in a tubular green compact forming container after feeding the raw material mixture into the container. The green compact forming step may be any one of a method of continuously forming a powder green compact, a method of forming a batch of powder green compacts.

In general, treatment for pressuring the raw material mixture in the green compact forming step is performed at a temperature from 10° C. to 35° C. without heating. When the raw material mixture is pressurized in the green compact forming step, a powder green compact is formed. In the green compact forming step, an alumina Al₂O₃ layer formed on the surface of the aluminum powder particle or alumina powder mixed separately from the aluminum powder is pressurized, and thus alumina is dispersed in the aluminum particle constituting the aluminum powder in some cases. When alumina is dispersed in the aluminum particle constituting the aluminum powder in the green compact forming step, the alumina part 30 is easily dispersed in the aluminum base material phase 10 in the aluminum base composite material 1A being a final product, which is preferred.

With this step, the powder green compact is obtained. The powder green compact thus obtained is used in a subsequent step, that is, the metal extrusion process step.

Note that the powder green compact may be subjected to a sintering step as appropriate for sintering at least part of the powder green compact. When the sintering step is performed, a risk of dust explosion can be reduced, which is preferred. A sintering temperature in the sintering step is set from 500° C. to 600° C., for example. In the sintering step, in general, the aluminum powder particles constituting the powder green compact are sintered together, and thus a sintered article is formed. Note that, in general, the carbon nanotube and alumina that are contained in the powder green compact before sintering are present on the surface of the aluminum particle forming the obtained sintered article. The sintered article thus obtained in the sintered step is used in a subsequent step, that is, the metal extrusion process step.

Hereinafter, a concept including the above-mentioned powder green compact and a sintered article is referred to as a “formed article before extrusion”. The formed article before extrusion is a solid article or a sintered article containing aluminum, a carbon nanotube, and alumina.

### (Metal Extrusion Process Step)

The metal extrusion process step is a step of subjecting the formed article before extrusion to an extrusion process. When the formed article before extrusion is a powder green compact, the metal extrusion process step is a step of subjecting the powder green compact to an extrusion process. When the formed article before extrusion is a sintered article, the metal extrusion process step is a step of subjecting the sintered article to an extrusion process.

In the metal extrusion process step, the formed article before extrusion is subjected to an extrusion process, and thus the aluminum base composite material 1 including the aluminum base material phase 10, the carbon nanotube part 20, and the alumina part 30 is produced from the formed article before extrusion.

For example, in the metal extrusion process step, the formed article before extrusion is heater, and is subjected to an extrusion process.

Heating of the formed article before extrusion is performed so that the temperature of the formed article before extrusion is generally 400° C. or higher, preferably 450° C. to 550° C., more preferably 480° C. to 520° C. When the temperature of the formed article before extrusion is lower than 400° C., it is difficult to perform an extrusion process. Further, when the temperature of the formed article before extrusion exceeds 550° C., there may be a risk that aluminum carbide is generated in the aluminum base composite material 1A.

A heating time of the formed article before extrusion changes depending on the formed article before extrusion and a volume of a heating furnace. When the heating time of the formed article before extrusion is, for example, 1 minute to 180 minutes, preferably 60 minutes to 120 minutes, temperature equalization of the formed article before extrusion is facilitated in the metal extrusion process step, which is preferred.

When the metal extrusion process step is completed, the aluminum base composite material 1A including the aluminum base material phase 10, the carbon nanotube part 20, the alumina part 30, and the impurity-derived dispersion part 40 can be obtained. The unprocessed aluminum base composite material 1A obtained after the metal extrusion process step is referred to as an “unprocessed composite material after extrusion”. Here, the term “unprocessed” indicates that physical treatment or chemical treatment, that is, a process other than “aging treatment” is not performed.

### [Electrical Connection Member]

The electrical connection member according to the present embodiment is a member formed by using the aluminum base composite material 1 according to the present embodiment. For example, a bus bar, a terminal, a bolt, or a nut is used as the electrical connection member. When the electrical connection member according to the present embodiment is used as a wiring member for an automobile, the electrical connection member can preferably exert excellent creep characteristics at a heat generating part such as an engine unit of an automobile and a member in a vicinity of a battery, that is, in an environment at a high temperature of approximately 150° C.

### (Effects)

The electrical connection member according to the present embodiment is formed by using the aluminum base composite material 1. Thus, part of the electrical connection member according to the present embodiment, which is formed by using the aluminum base composite material 1, has excellent creep characteristics at a high temperature, specifically, creep characteristics at 150° C.

### EXAMPLES

The present embodiment is further described below in detail with Examples and Comparative Examples. However, the present embodiment is not limited to those examples.

### Example 1

### (Manufacturing of Aluminum Base Composite Material)

### <CNT-Alcohol Dispersion Preparing Step>

A carbon nanotube having an average diameter from 10 nm to 15 nm was added to 2-propanol, and was mixed for 60 minutes through use of Spike Mill (registered trademark) SHG-10 produced by INOUE MFG., INC. With this, a CNT-alcohol dispersion was prepared. Zirconia beads each having a diameter or 1.0 mm were fed into Spike Mill.

The addition amount of the carbon nanotube to 2-propanol was adjusted so that an aluminum base composite material to be obtained as a final product had 99.5 mass % of the total amount of aluminum and inevitable impurities and 0.5 mass % of the carbon nanotube.

The CNT-alcohol dispersion was adjusted to have viscosity falling within a range from 1 mPa·s to 3,000 mPa·s at 25° C.

### <Raw Material Mixture Slurry Preparation Step>

Aluminum powder was added to the CNT-alcohol dispersion, and was mixed for 60 minutes through use of Spike Mill described above. With this, a raw material mixture slurry was prepared. The aluminum powder used herein had a spherical particle shape having an average particle diameter falling within a range from 75 μm to 150 μm, and had a surface on which an aluminum oxide coated film was formed. Zirconia beads each having a diameter of 1.0 mm were fed into Spike Mill.

The addition amount of the aluminum powder was adjusted so that an aluminum base composite material to be obtained as a final product had 99.5 mass % of the total amount of aluminum and inevitable impurities and 0.5 mass % of the carbon nanotube.

In the raw material mixture slurry thus obtained, almost all the carbon nanotubes adhered to the surface of the flattened aluminum powder due to a Van der Waals force.

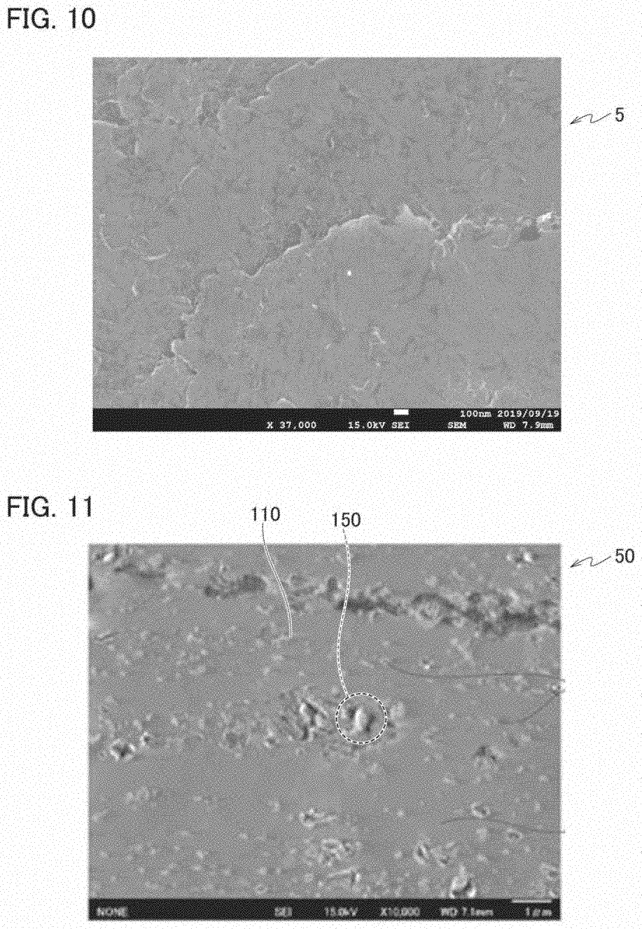

FIG. 10 is an example of a scanning electron microscopic (SEM) photograph of the surface of the aluminum powder in the raw material mixture slurry in Example 1. In FIG. 10, a number of string-like matters observed on a surface of flattened aluminum powder 5 correspond to the carbon nanotube parts 20. With reference to FIG. 10, it was confirmed that the carbon nanotube parts 20 were present on the surface of the flattened aluminum powder 5.

### <Raw Material Mixture Drying Step>

An evaporator was used to evaporate and collect 2-propanol from the raw material mixture slurry, and thus the raw material mixture slurry was dried. With this, a raw material mixture containing the flattened aluminum powder and the carbon nanotube was obtained.

### <Green Compact Forming Step>

A rotary tablet machine was used to compact the raw material mixture in the atmosphere at 25° C., and a green compact (metal pellet) having a diameter of 5 mm and a height of 5 mm was produced. Note that, for reference, a hand press machine was used to compact the raw material mixture in the atmosphere at 25° C., and thus a green compact having a diameter of 60 mm and a height of 10 mm was obtained.

### <Metal Extrusion Process Step>

The green compact (metal pellet) was held under the atmospheric pressure at a dice temperature of 500° C. for 10 minutes, and was subjected to an extrusion process.

After an extrusion process was completed, a polygonal pillar-shaped aluminum base composite material (Sample No. A1) having a width of 20 mm and a thickness of 2.0 mm was obtained. The aluminum base composite material thus obtained was an unprocessed composite material after extrusion, that is, an unprocessed material prepared in the metal extrusion process step without performing physical treatment or chemical treatment, that is, a process other than “aging treatment”.

### (Evaluation)

The aluminum base composite material thus obtained (unprocessed composite material after extrusion) was evaluated with regard to the following aspects.

### <Observation of Cross Section>

The cross section of the aluminum base composite material thus obtained (unprocessed composite material after extrusion) was observed with a scanning electron microscope (SEM), and components thereof were analyzed by an energy dispersive X-ray spectroscopy (EDS).

Further, based on the SEM observation, a size, the number, and the like of each of the base material part 11 and the dispersion parts that are included in the aluminum base composite material 1 were examined. The dispersion parts being examination targets were the carbon nanotube part 20, the alumina part 30, the impurity-derived dispersion part 40, and parts formed of other substances dispersed in the base material part 11.

The results are shown in Table 1, and FIG. 1 to FIG. 6.

TABLE 1

| | | | Dispersion part | | | | | | | | | |
|---|---|---|---|---|---|---|---|---|---|---|---|---|
| | | | | | Size (μm) | | | | | | | |
| | | Base | | | CNT | | Al₂O₃ | | | | | |
| | | material | | | Lower | Upper | Lower | Upper | Al₄C₃ | Number density | | |
| | Sample | part | | | limit | limit | limit | limit | Average | (number/μm²) | | |
| | No. | Material | Material | | value | value | value | value | value | CNT | Al₂O₃ | Al₄C₃ |
| Example 1 | A1 | Aluminum | CNT | Al₂O₃ | 0.02 | 0.2 | 0.02 | 2.5 | — | 5 | 40 | — |
| Example 2 | A2 | Aluminum | CNT | Al₂O₃ | 0.02 | 0.2 | 0.02 | 2.5 | — | 8 | 53 | — |
| Example 3 | A3 | Aluminum | CNT | Al₂O₃ | 0.02 | 0.2 | 0.02 | 2.5 | — | 11 | 59 | — |
| Comparative | B1 | Al-Mg alloy | Mg₂Si | — | — | — | — | — | — | — | — | — |
| Example 1 | | | | | | | | | | | | |
| Comparative | B2 | Al-Fe alloy | Al₃Fe | — | — | — | — | — | — | — | — | — |
| Example 2 | | | | | | | | | | | | |
| Comparative | B3 | Aluminum | Inevitable | — | — | — | — | — | — | — | — | — |
| Example 3 | | | impurities | | | | | | | | | |
| Comparative | B4 | Aluminum | Al₄C₃ | — | — | — | — | — | 0.1 | — | — | 55 |
| Example 4 | | | | | | | | | | | | |

FIG. 1 is an example of an SEM photograph of the cross section of the aluminum base composite material according to Example 1. FIG. 2 is an example of an enlarged photograph of FIG. 1. FIG. 3A is an example of an enlarged photograph of FIG. 1, which is obtained by further enlarging FIG. 2. FIG. 3B is a carbon mapping image of a region shown in FIG. 3A, which is obtained by an energy dispersive X-ray spectroscopy (EDS). FIG. 4 is an example of a transmission electron microscopic (TEM) photograph in a magnifying manner, focusing on carbons in FIG. 3A. FIG. 5A is an example of an EDS analysis result of the black point BK₁ in FIG. 1. FIG. 5B is an example of an EDS analysis result of the white point WH₁ in FIG. 1. FIG. 6 is an example of a graph showing a relationship between a particle area of a large number of alumina parts (alumina part cross-sectional area) and a frequency, the large number of alumina parts being present in the cross section of the aluminum base composite material shown in FIG. 1.

As shown in FIG. 1 to FIG. 3B, the aluminum base composite material 1 included the aluminum base material phase 10, the carbon nanotube part 20, the black point BK₁, and the white point WH₁. Here, with reference to FIG. 5A, it was understood that the black point BK₁ was the alumina part 30 formed of Al₂O₃. Further, with reference to FIG. 5B, it was understood that the white point WH₁ was the impurity-derived dispersion part 40 formed of an inter-metal compound of Al, Fe, and Cu.

Therefore, it was understood that the aluminum base composite material 1 shown in FIG. 1 to FIG. 3B included the aluminum base material phase 10, the carbon nanotube part 20, the alumina part 30, and the impurity-derived dispersion part 40.

Further, with reference to FIG. 6, it was understood that the particle area of the alumina parts 30 fell within a range from 0.02 μm² to 2.5 μm² in the cross-sectional area of 3,000 μm² of the cross section of the aluminum base composite material 1.

### <Element Analysis>

A transmission electron microscope (TEM) and an energy dispersive X-ray spectroscopy (EDS) were used to perform a further element analysis on the base material part 11 and the dispersion parts in the aluminum base material phase 10 included in the aluminum base composite material 1. The dispersion parts being examination targets were the carbon nanotube part 20, the alumina part 30, the impurity-derived dispersion part 40, and parts formed of other substances dispersed in the base material part 11.

The results are shown in Table 2. In Table 2, the column CNT in the dispersion part indicates the carbon nanotube part 20, and the column Al₂O₃ in the dispersion part indicates the alumina part 30. Note that the column Al₄C₃ in the dispersion part indicates the parts formed of other substances.

TABLE 2

| | | Aluminum base material phase (mass %) | | | | | | | | | | | | |
|---|---|---|---|---|---|---|---|---|---|---|---|---|---|---|
| | | Base material part (mass %) | | | | | | | | | | Dispersion | | |
| | Sample | | | | | | | | | | Other | part (mass %) | | |
| | No. | Al | Si | Fe | Cu | Mn | Mg | Cr | Zn | Ti | impurities | CNT | Al₂O₃ | Al₄C₃ |
| Example 1 | A1 | 99.17 | 0.04 | 0.12 | 0.003 | 0.004 | — | — | — | 0.007 | 0.016 | 0.436 | 0.20 | — |
| Example 2 | A2 | 99.03 | 0.04 | 0.12 | 0.003 | 0.004 | — | — | — | 0.007 | 0.016 | 0.438 | 0.34 | — |
| Example 3 | A3 | 98.97 | 0.04 | 0.12 | 0.003 | 0.004 | — | — | — | 0.007 | 0.016 | 0.440 | 0.40 | — |
| Comparative | B1 | 98.51 | 0.40 | 0.30 | 0.08 | 0.05 | 0.46 | 0.04 | 0.03 | 0.007 | 0.12 | — | — | — |
| Example 1 | | | | | | | | | | | | | | |
| Comparative | B2 | 99.00 | 0.04 | 0.56 | 0.00 | 0.00 | 0.30 | — | — | 0.002 | 0.10 | — | — | — |
| Example 2 | | | | | | | | | | | | | | |
| Comparative | B3 | 99.69 | 0.10 | 0.15 | 0.02 | 0.003 | 0.01 | — | 0.01 | 0.008 | 0.01 | — | — | — |
| Example 3 | | | | | | | | | | | | | | |
| Comparative | B4 | 99.31 | 0.04 | 0.12 | 0.003 | 0.004 | — | 0.100 | — | 0.007 | 0.016 | — | — | 0.4 |
| Example 4 | | | | | | | | | | | | | | |

Tensile strength, 0.2% proof stress, breaking elongation, conductivity, and creep characteristics of the aluminum base composite material thus obtained (unprocessed composite material after extrusion) were measured in the following manner.

### <Tensile Strength, 0.2% Proof Stress, Breaking Elongation>

The polygonal pillar test piece having a width 20 mm and a thickness of 2.0 mm was used to measure tensile strength, 0.2% proof stress, and breaking elongation. The results are shown in Table 3. Note that, in Comparative Examples 1 to 4 described later, a wire rod having a diameter from 0.3 mm to 1.0 mm was used to measure tensile strength, 0.2% proof stress, and breaking elongation.

TABLE 3

| | | | 0.2% | | | |
|---|---|---|---|---|---|---|
| | | Tensile | proof | Breaking | | |
| | Sample | strength | stress | elongation | Conductivity | Creep |
| | No. | (MPa) | (MPa) | (%) | (% IACS) | characteristics |
| Example 1 | A1 | 122.4 | 84.5 | 22.4 | 61.0 | Satisfactory |
| Example 2 | A2 | 139.2 | 81.6 | 23.0 | 60.8 | Satisfactory |
| Example 3 | A3 | 145.8 | 81.8 | 22.2 | 60.2 | Satisfactory |
| Comparative | B1 | 217.1 | 183.5 | 12.5 | 54.8 | Poor |
| Example 1 | | | | | | |
| Comparative | B2 | 123.7 | 84.1 | 30.8 | 58.3 | Poor |
| Example 2 | | | | | | |
| Comparative | B3 | 70.5 | 31.4 | 35.3 | 62.2 | Poor |
| Example 3 | | | | | | |
| Comparative | B4 | 169.0 | 140.0 | 36.9 | 58.1 | Poor |
| Example 4 | | | | | | |

### <Conductivity>

The polygonal pillar test piece having a width 20 mm and a thickness of 2.0 mm was used to measure a conductor resistance according to JIS H 0505, and thus conductivity was measured. The results are shown in Table 3.

### <Creep Characteristics>

The polygonal pillar test piece having a width of 20 mm, a thickness of 2.0 mm, and a length of 300 mm was used to measure creep characteristics. Note that the length of the test piece was changed as appropriate according to specifications of a test machine. Specifically, the test piece was set to a chuck part of a creep test machine, and a load corresponding to 80% of a value of 0.2% proof stress was applied to the test piece under a condition of a temperature of 150° C. in the atmosphere. Thus, a relationship between a time and displacement was measured. Further, a time required until the test piece broke (creep rupture time) or displacement up to 500 hours to the maximum was measured.

Creep characteristics were evaluated as “poor” when the creep rupture time was 500 hours or less, and were evaluated as “satisfactory” when the creep rupture time did not arrive within 500 hours. The results are shown in Table 3 and FIG. 7. In FIG. 7, Example 1 is indicated as “Aluminum base composite material”.

### Example 2

### (Production of Aluminum Base Composite Material)

A polygonal pillar-shaped aluminum base composite material (unprocessed composite material after extrusion, Sample No. A2) having a width of 20 mm and a thickness of 2.0 mm was obtained similarly to Example 1, except that aluminum powder having an average particle diameter of 75 μm was used.

### (Evaluation)

Observation of the cross section and an element analysis were performed for the aluminum base composite material thus obtained (unprocessed composite material after extrusion) similarly to Example 1, and tensile strength, 0.2% proof stress, breaking elongation, conductivity, and creep characteristics were measured. The results are shown in Table 1 to Table 3.

### Example 3

### (Production of Aluminum Base Composite Material)

A polygonal pillar-shaped aluminum base composite material (unprocessed composite material after extrusion, Sample No. A3) having a width of 20 mm and a thickness of 2.0 mm was obtained similarly to Example 1, except that aluminum powder having an average particle diameter of 45 μm was used.

### (Evaluation)

Observation of the cross section and an element analysis were performed for the aluminum base composite material thus obtained (unprocessed composite material after extrusion) similarly to Example 1, and tensile strength, 0.2% proof stress, breaking elongation, conductivity, and creep characteristics were measured. The results are shown in Table 1 to Table 3.

### Comparative Example 1

### (Production of Aluminum Base Composite Material)

A commercially-available polygonal pillar test piece (Sample No. B1) that had a width of 20 mm and a plate thickness of 2.0 mm and was formed of an aluminum alloy A6063-T5 was used in place of the aluminum base composite material in Example 1. Further, a wire rod test piece that was formed of the aluminum alloy A6063-T5 and had a diameter from 0.3 mm to 1.0 mm was also produced.

### (Evaluation)

The polygonal pillar test piece was used to perform an element analysis and measure conductivity and creep characteristics, and the wire rod test piece was used to measure tensile strength, 0.2% proof stress, and breaking elongation.

Specifically, the element analysis was performed, and conductivity and creep characteristics were measured similarly to Example 1, except that the polygonal pillar test piece that had a width of 20 mm and a plate thickness of 2.0 mm and was formed of the aluminum alloy A6063-T5 was used in place of the test piece formed of the aluminum base composite material in Example 1.

Further, tensile strength, 0.2% proof stress, and breaking elongation were measured similarly to Example 1, except that the wire rod test piece having a diameter 0.3 mm to 1.0 mm was used in place of the test piece formed of the aluminum base composite material in Example 1.

The results are shown in Table 2 and Table 3, and FIG. 7. In FIG. 7, Comparative Example 1 is indicated as “A6063-T5”.

### Comparative Example 2

### (Production of Aluminum Base Composite Material)

An Al—Fe based alloy (Sample No. B2) used for a low voltage wire of an automobile was used to produce a polygonal pillar test piece having a width 20 mm, a plate thickness of 2.0 mm, in place of the aluminum base composite material in Example 1. Further, a wire rod test piece that was formed of the above-mentioned Al—Fe based alloy and had a diameter from 0.3 mm to 1.0 mm was also produced.

### (Evaluation)

Specifically, the element analysis was performed, and conductivity and creep characteristics were measured similarly to Example 1, except that the polygonal pillar Al—Fe alloy test piece having a width of 20 mm and a plate thickness of 2.0 mm was used in place of the test piece formed of the aluminum base composite material in Example 1.

The polygonal pillar test piece was used to perform an element analysis and measure conductivity and creep characteristics, and the wire rod test piece was used to measure tensile strength, 0.2% proof stress, and breaking elongation.

Further, tensile strength, 0.2% proof stress, and breaking elongation were measured similarly to Example 1, except that the wire rod test piece having a diameter 0.3 mm to 1.0 mm was used in place of the test piece formed of the aluminum base composite material in Example 1.

The results are shown in Table 2 and Table 3, and FIG. 7. In FIG. 7, Comparative Example 2 is indicated as “Al—Fe alloy.

### Comparative Example 3

### (Production of Aluminum Base Composite Material)

Commercially-available pure aluminum A1070-O (Sample No. B3) having a width of 20 mm and a plate thickness of 2.0 mm was used in place of the aluminum base composite material in Example 1. Further, a wire rod test piece that was formed of the pure aluminum A1070-O and had a diameter from 0.3 mm to 1.0 mm was also produced.

### (Evaluation)

The polygonal pillar test piece was used to perform an element analysis and measure conductivity and creep characteristics, and the wire rod test piece was used to measure tensile strength, 0.2% proof stress, and breaking elongation.

Specifically, the element analysis was performed, and conductivity and creep characteristics were measured similarly to Example 1, except that the polygonal pillar A1070-O test piece having a width of 20 mm a plate thickness of 2.0 mm was used in place of the test piece formed of the aluminum base composite material in Example 1.

Further, tensile strength, 0.2% proof stress, and breaking elongation were measured similarly to Example 1, except that the wire rod test piece having a diameter 0.3 mm to 1.0 mm was used in place of the test piece formed of the aluminum base composite material in Example 1.

The results are shown in Table 3.

### Comparative Example 4

### (Production of Aluminum Base Composite Material)

An aluminum base composite material in which a carbon nanotube was only present at a particle boundary of adjacent aluminum base material phases 10 was used in place of the aluminum base composite material in Example 1. An aluminum base composite material (unprocessed composite material after extrusion, Sample No. B4) was obtained similarly to Example 1 except for the above-mentioned matter. The aluminum base composite material being Sample No. B4 was produced in the following manner.

First, aluminum powder and a carbon nanotube were weighed so that a content amount of aluminum carbide in an aluminum base composite material to be obtained was 0.40 mass %. Note that ALE16PB (product name) produced by Kojundo Chemical Lab. Co., Ltd was used as the aluminum powder, and its average powder diameter was 20 μm. Further, Flotube9000G2 (product name) produced by Cnano Technology Limited was used as the carbon nanotube.

Next, the aluminum powder and the carbon nanotube after weighing were fed into a pot of a planet ball mill, and were subjected to rotation treatment. With this, mixture powder was prepared. The planet mill was used, and hence the aluminum powder in the mixture powder had a flattened shape. Subsequently, the mixture powder thus obtained was fed into a die, and a pressure of 600 MPa was applied thereto at a normal temperature. With this, a green compact was prepared.

An electric furnace was used to heat the green compact thus obtained for 300 minutes at 630° C. in vacuum, and thus an aluminum base composite material (unprocessed composite material after extrusion) was prepared. The aluminum base composite material was an aluminum base composite material in which the carbon nanotube was only present at a particle boundary between adjacent aluminum base material phases 10.

Further, the aluminum base composite material thus obtained (unprocessed composite material after extrusion) was subjected to a wire drawing process, and thus an aluminum base composite material (wire rod test piece, Sample No. B4) being a wire rod having a diameter of 1.0 mm was obtained.

### (Evaluation)

An element analysis and the like were performed similarly to Example 1, except that the wire rod test piece having a diameter of 1.0 mm was used in place of the test piece formed of the aluminum base composite material in Example 1. Specifically, observation of the cross section and the element analysis were performed, and tensile strength, 0.2% proof stress, breaking elongation, conductivity, and creep characteristics were measured similarly to Example 1, except that the wire rod test piece having a diameter of 1.0 mm was used. The results are shown in Table 3 and FIG. 11.

FIG. 11 is an example of a scanning electron microscopic (SEM) photograph of the cross section of the aluminum base composite material in Comparative Example 4.

With reference to FIG. 11, it can be understood that a dispersion part 150 formed on Al₄C₃ was dispersed in an aluminum base material phase 110 of an aluminum base composite material 50 in Comparative Example 4.

### Example 4

### (Production of Aluminum Base Composite Material)

Work-hardening characteristics and softening characteristics of the aluminum base composite material were examined. Specifically, an aluminum base composite material that had the same composition of Example 1 (Sample No. A1) and had a wire rod-like shape having a diameter of 2.6 mm (unprocessed composite material after extrusion, Sample No. C1) was subjected to wire drawing treatment, heat treatment, and the like, and thus aluminum base composite materials (Sample No. C2 to Sample No. C4) were prepared. Hereinafter, the unprocessed composite material after extrusion in Sample No. C1 is referred to as a “material after extrusion”.

Specifically, the material after extrusion (Sample No. C1) was subjected to wire drawing treatment with equivalent strain t of 3.32, and thus a “material after wire drawing” (Sample No. C2) was obtained. The material after wire drawing was a wire rod test piece having a diameter of 0.55 mm.

Further, the material after wire drawing (Sample No. C2) was subjected to heat treatment for one hour at 325° C., and thus a “material after heat treatment” (Sample No. C3) was obtained.

Moreover, the material after wire drawing (Sample No. C2) was subjected to heat treatment for one hour at 400° C., and thus a “material after heat treatment” (Sample No. C4) was obtained.

### (Evaluation)

Tensile strength, yield stress, and elongation of each of the aluminum base composite materials thus obtained (Sample No. C1 to Sample No. C4) were measured. Note that tensile strength and elongation of the material after extrusion (Sample No. C1) were measured in Example 1, and hence only yield stress was measured without additional measurement. Yield stress was measured in the following manner.

### <Yield Stress>

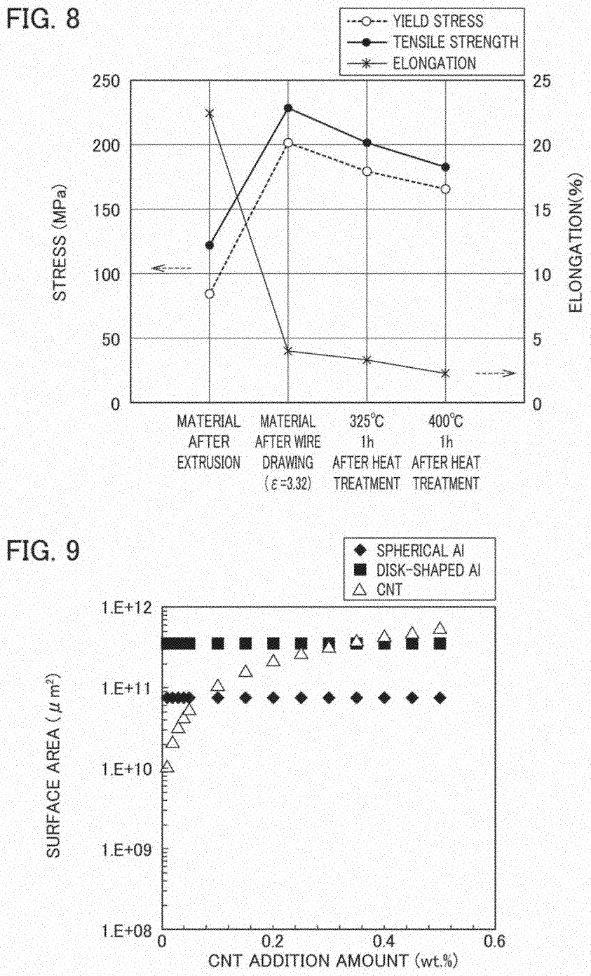

For each of Sample No. C1 to Sample No. C4, the test piece having a diameter of 0.55 mm was used, and yield stress was measured in a tensile test. Note that the test piece having a diameter of 0.55 mm, which corresponds to Sample No. C1, was prepared by subjecting the above-mentioned wire rod aluminum base composite material having a diameter of 2.6 mm to a wire drawing process. The results are shown in FIG. 8.

The values measured in Example 1 were used as tensile strength and elongation of the material after extrusion (Sample No. C1). Further, in FIG. 8, the material after heat treatment being Sample No. C3 is indicated as “325° C., 1 h, after heat treatment”, and the material after heat treatment being Sample No. C4 is indicated as “400° C., 1 h. after heat treatment”.

With reference to FIG. 8, it was understood that the two material after heat treatments (Sample No. C3 and Sample No. C4) obtained by subjecting the material after wire drawing (Sample No. C2) to heat treatment had elongation smaller than the material after wire drawing (Sample No. C2) and ductility thereof was not improved. In other words, it was clearly understood that recrystallization was not completed in Sample No. C3 and Sample No. C4.

Note that a general aluminum alloy material is crystallized through heat treatment at a temperature from 250° C. to 350° C., and hence ductility thereof is improved as compared to that before heat treatment.

In contrast, ductility of the material after heat treatments (Sample No. C3 and Sample No. C4), which were obtained by subjecting the material after wire drawing (Sample No. C2) to heat treatment at 325° C. and 400° C., was not improved as compared to that of the material after wire drawing (Sample No. C2). Thus, it was understood that the aluminum base composite material in Example 1 (Sample No. A1 and Sample No. C1) had behavior with respect to heat treatment, which was completely different from a general aluminum alloy material.

Such unique behavior of the aluminum base composite material in Example 1 (Sample No. A1 and Sample No. C1) with respect to heat treatment was presumably caused by the microscopic structure of the aluminum base composite material in Example 1 that hindered dislocation movement such as transfer of dislocation and restoration.

Based on the results such as creep characteristics in Examples 1 to 3 and Comparative Examples 1 to 4 and the results such as heat treatment characteristics in Example 4, it was understood that the aluminum base composite materials in Example 1 to 3 had excellent creep characteristics at a high temperature.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An aluminum base composite material, comprising:
an aluminum polycrystal body being a polycrystal body of a plurality of aluminum base material phases partitioned by a grain boundary;
a carbon nanotube part being formed of a carbon nanotube or an aggregate thereof and being dispersed in at least one of the plurality of aluminum base material phases; and
an alumina part being formed of alumina and being dispersed in at least one of the plurality of aluminum base material phases.

2. The aluminum base composite material according to claim 1, wherein
a carbon nanotube or a carbon nanotube aggregate that forms the carbon nanotube part has a sphere-equivalent diameter from 10 nm to 300 nm, and
the number of the carbon nanotube part that is present in a cross-sectional area of 200 μm² of the aluminum base composite material is one or more.

3. The aluminum base composite material according to claim 1, further comprising an impurity-derived dispersion part being formed of a compound containing one or more elements selected from a group consisting of Fe, Cu, Si, Mn, Ti, and Zn and being dispersed in at least one of the plurality of aluminum base material phases.

4. The aluminum base composite material according to claim 1, wherein
the alumina part has an alumina part cross-sectional area of 0.075 μm² to 67.90 μm² that is present in a cross-sectional area of 3,000 μm² of a cross section of the aluminum base composite material, the alumina part cross-sectional area being a cross-sectional area of the alumina part observed in the cross section of the aluminum base composite material.

5. An electrical connection member being formed by using the aluminum base composite material according to claim 1.

6. The electrical connection member according to claim 5, wherein
the electrical connection member comprises a bus bar, a terminal, a bolt, or a nut.

7. The electrical connection member according to claim 5, wherein
the electrical connection member is used as a wiring member for an automobile.

8. A method of manufacturing an aluminum base composite material, comprising:
a CNT-alcohol dispersion preparation step of preparing a CNT-alcohol dispersion in which a carbon nanotube is dispersed in alcohol;
a raw material mixture slurry preparation step of preparing a raw material mixture slurry by adding aluminum powder in the CNT-alcohol dispersion, the raw material mixture slurry containing, in alcohol, the aluminum powder, the carbon nanotube, and alumina;
a raw material mixture drying step of drying the raw material mixture slurry and producing a raw material mixture;
a green compact forming step of pressurizing the raw material mixture, obtaining a preliminary compact, and forming a powder green compact; and
a metal extrusion process step of subjecting the powder green compact to an extrusion process.
